(19) United States
(12) Patent Application Publication
(10) Pub. No.: US 2026/0077422 A1
(43) Pub. Date: Mar. 19, 2026

(54) Machining head for thermal and/or mechanical machining of workpieces, arrangement comprising same, and method for connecting and separating a front and a rear part of a machining head

(71) Applicant: Kjellberg-Stiftung, Finsterwalde (DE)

(72) Inventors: Timo Grundke, Finsterwalde (DE); Markus Koch, Heinersbruck (DE); Volker Krink, Finsterwalde (DE)

(73) Assignee: Kjellberg-Stiftung, Finsterwalde (DE)

(21) Appl. No.: 18/889,312

(22) Filed: Sep. 18, 2024

(30) Foreign Application Priority Data
Sep. 17, 2024 (DE) 10 2024 126 772.0

(51) Int. Cl. B23K 10/00

(52) U.S. Cl. CPC B23K 10/006

(57) ABSTRACT

A machining head for thermal and/or mechanical machining of workpieces, which extends along a longitudinal axis L, comprising a front part and a rear part, the front part comprising at least one nozzle with an opening, which during operation has thermal and/or mechanical energy for workpiece machining leaving it, the rear part being connected or connectable to operating-media supply devices and the rear part and the front part being connectable detachably to and separable from one another, wherein the rear part and/or the front part have/has a drive device, which are/is configured to move the front part at least partially along the longitudinal axis L relative to the rear part for connection purposes and in the opposite direction relative to the rear part for separation purposes.

### BACKGROUND

The present invention relates to a machining head for thermal and/or mechanical machining of workpieces, to an arrangement comprising same, and to a method for connecting and separating a front and a rear part of a machining head.

Machining heads for thermal machining methods are for example arc torches, plasma torches or plasma arc torches.

Special embodiments of such torches are e.g. plasma torches for cutting, what are referred to as plasma cutting torches, and e.g. torches for welding, what are referred to as plasma welding torches or TIG torches.

Thermal and mechanical machining methods make use of wearing parts, which wear out as a result of the operation.

The head of a torch (in the following text also referred to as torch head) contains at least the following wearing parts: nozzle and electrode. Furthermore, further parts, such as a gas routing means, insulating parts or/and caps and also a mount therefor may be located in the torch head.

The electrode and nozzle are wearing parts, which owing in particular to the high thermal loading wear out and need to be exchanged regularly.

In the shaft of a torch (in the following text also referred to as torch shaft), there is at least one supply line for a gas and a supply line for an electrical current and a fluid passage. Connected to the torch shaft are the corresponding lines for supplying the torch, in particular the plasma torch, with electrical current, gas and, depending on the embodiment, cooling water and further gases.

Exchanging the wearing parts is, however, also necessary when there is a changeover in the technological parameters. If work is carried out for example with different currents or different gases, the wearing parts must be exchanged. This also applies to the changeover between plasma cutting and plasma marking, this being possible with a plasma torch. Similarly, it is often expedient to exchange the wearing parts between the puncturing operation and the cutting operation.

A plasma cutting torch is usually incorporated in a guide system, a CNC-controlled guide machine or a robot, which guides the plasma torch. In order to avoid damage owing to collisions, the mount for the plasma cutting torch is provided with an anticollision means, which triggers on a collision of the plasma torch, for example with the workpiece, and stops the movement.

It usually takes a lot of time to exchange the individual wearing parts, since the parts on their own often need to be exchanged in collaboration with a tool.

In order to be able to perform an exchange as quickly as possible, there are plasma cutting torches that consist of a front part and a rear part, which can be connected to and separated from one another. The front part is referred to as torch head, the rear part is referred to as torch shaft, and the overall machining head is referred to as quick-exchange plasma torch.

It is known that the torch head and the torch shaft can be connected to or separated from one another using a threaded connection or a bayonet closure. This connection and separation is generally done manually. A mechanized exchange is only possible with considerable additional outlay using a further apparatus, such as an external drive for rotating the threaded connection or the bayonet closure. This is necessary in order to be able to effect the exchange without exertion of a force on the anticollision means, which otherwise would trigger.

The necessary travel to be covered by the rotational movement is considerably longer than the travel required for separating or connecting along the longitudinal axis of the quick-exchange plasma torch. Therefore, the rotational movement also requires more time to separate the torch head from the torch shaft and to connect the torch head to the torch shaft.

Up to now, there are no plasma torches that have a device enabling an exchange between a torch head and a torch shaft which is neutral in terms of force for the anticollision device, is mechanized, is quick and has low outlay.

Machining heads for thermal and/or mechanical machining methods can also be gas torches, for example what are referred to as oxyacetylene torches. Here, the thermal energy is utilized by the combustion of combustible gases, for example hydrogen, propane, acetylene usually in combination with oxygen, which is a combustion promoter. A typical application is oxyacetylene cutting.

Machining heads for thermal and/or mechanical machining methods can also be heads for laser methods. Here, the laser radiation is directed and focussed onto the workpiece such that the workpiece is heated by absorption of the laser radiation.

A typical application is laser cutting. By selectively directing a gas flow onto the workpiece, the workpiece is oxidized by the gas oxygen and “combusts”. This is laser oxygen cutting. Laser fusion cutting makes use of non-oxidizing gas, for example nitrogen, and involves the melted workpiece being expelled by a gas jet of non-oxidizing gas.

Machining heads for mechanical machining methods can also be heads for waterjet blasting methods. In this case, a high fluidic pressure is used to mechanically sever the workpiece, specifically waterjet cutting. In addition, a gas and an abrasive can be added to the water.

### SUMMARY

The invention is based on the object of enabling quick and straightforward mechanical separation and connection of a front part and a rear part of a machining head.

According to the invention, this object is achieved by a machining head, an arrangement, and a method as claimed.

The dependent claims relate to respective particular embodiments.

The present invention is based on the surprising finding that the, in particular special, drive device enables quick and straightforward mechanical separation and connection of a front part and a rear part of a machining head. With preference, this is effected by means of a completely or mainly linear relative movement of the front and rear parts of the machining head.

At least in one particular embodiment, the front and rear parts of the machining head are not screwed to one another.

At least in one particular embodiment, the connecting and/or separating is effected in automated fashion.

At least in one particular embodiment, the separating and connecting are effected without exerting a force on the mount of the machining head, for example on an anticollision device fastened thereto.

In addition, at least in one particular embodiment, it is made possible, in mechanical and/or automated guide systems, to separate the front from the rear part or connect the two to one another, in order for example to be able to exchange worn parts (wearing parts). Similarly, it is possible to change between different technologies. This change can be effected in automated fashion.

### BRIEF DESCRIPTION OF DRAWINGS

Further features and advantages of the invention emerge from the appended claims and on the basis of the following description of particular embodiments with reference to the schematic illustrations.

FIG. 1a shows a schematic side view of a machining head according to one particular embodiment of the present invention;

FIG. 1b shows a detail of FIG. 1a;

FIGS. 2a to 2d show a method for connecting and separating a front part and a rear part of the machining head from FIG. 1 according to one particular embodiment of the present invention;

FIG. 3a shows a side view of a plasma cutting torch; and

FIG. 3b shows a view of the drive unit of the torch shaft of the plasma cutting torch from FIG. 3a;

FIG. 3c shows a 3D view of the torch shaft of the plasma cutting torch from FIG. 3a with the drive unit; and

FIG. 4 shows an arrangement for thermal and/or mechanical machining of workpieces according to one particular embodiment of the present invention.

### DETAILED DESCRIPTION

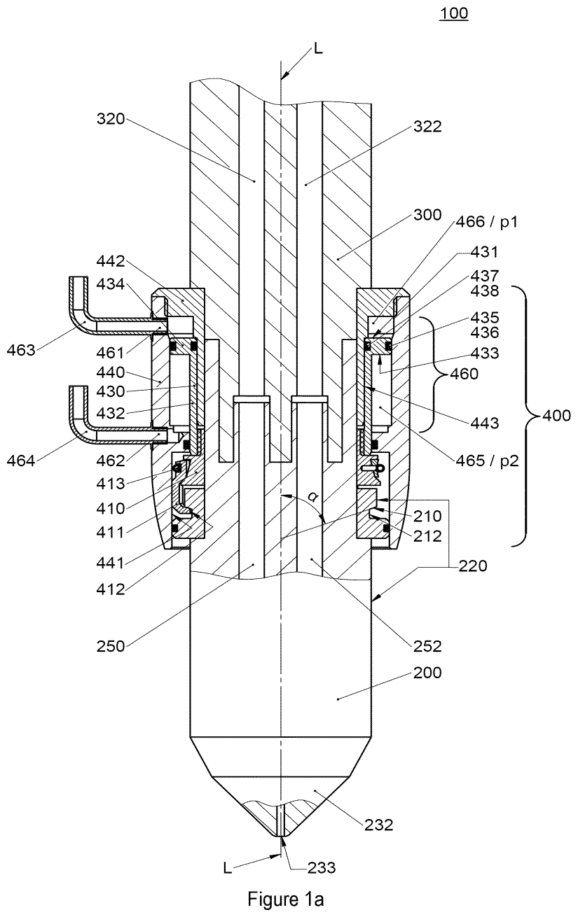

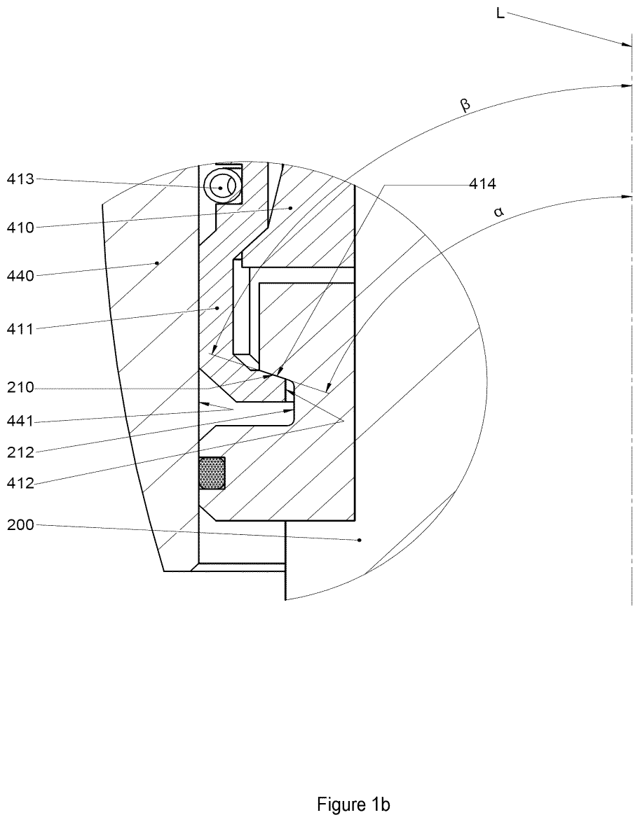

FIG. 1a shows, by way of example, a schematic side view of a machining head 100 for thermal and/or mechanical machining of workpieces in one particular embodiment of the invention. The machining head 100 extends along a longitudinal axis L and comprises a front part 200 and a rear part 300, and also a drive device 400. In this example, the machining head is a two-part machining head. It could, in particular between the front part 200 and the rear part 300, have at least one further part.

The front part 200 comprises a nozzle 232 with a nozzle opening 233, which during operation has thermal and/or mechanical energy for workpiece machining leaving it. Furthermore, the front part comprises leadthroughs 250 and 252 for current and gas. It is however also possible for further leadthroughs for e.g. water and one or more further gases to be present.

The rear part 300 comprises the feed lines 320, 322, for example for gas or electrical current. It may also have further feed lines and passages for e.g. water, for example as cooling medium, for further gases or electrical current.

The front part 200 and the rear part 300 are connected detachably to one another.

The drive device 400 is situated in this example on the rear part 300. In the drive device 400 there is a gripper 410, which has fingers 411, here by way of example three, with a respective tip 412 and a surface 414, and also for example a resilient or magnetic element 413. The gripper 410 may in principle have one or more than one resilient and/or magnetic element.

Furthermore, the drive device 400 comprises a cylinder 460, which has an outer sleeve 440, an inner sleeve 442 and a component 430. The component 430 in this case and by way of example is a cylinder piston, comprising a cylindrical sleeve 432 and an encircling flange 434. The inner sleeve 442, the outer sleeve 440 and the cylinder piston 430 form two chambers 465 and 466. The outer sleeve 440 has two fluid passages 461 and 462. The fluid passage 461 connects the chamber 466 to a line 463 and the fluid passage 462 connects the chamber 465 to a line 464, these lines being for the feed of compressed air to and the evacuation of the respective chamber. The compressed-air feed and the evacuation are controlled via solenoid valves and a control device, which are not illustrated here.

The two chambers 465 and 466 are separated by the flange 434, which has, encircling its inner surface and its outer surface, a groove 435 and 437, respectively, with an O ring 436 and 438, respectively, for sealing with respect to the inner surface 441 of the outer sleeve 440 and to the outer surface 443 of the inner sleeve 442. That surface 433 of the flange 434 that delimits the chamber 465 is smaller than that surface 431 of the flange 434 that delimits the chamber 466. This ensures that, given the same pressure p1 and p2, the force provided for separating purposes is greater than the force provided for connecting purposes.

If a pressure is fed to the chamber 465 and the chamber 466 has a pressure considerably lower, preferably a pressure at least 3 bar lower, than the chamber 465 and at best is virtually pressure-free owing to the evacuation, the cylinder piston 430 is moved in the direction toward the rear part, or kept in this position illustrated here. This makes it possible to connect the front part 200 to the rear part 300, or keep them connected.

If a pressure is fed to the chamber 466 and the chamber 465 has a pressure lower, preferably a pressure at least 1 bar lower, than the chamber 466 and at best is virtually pressure-free owing to the evacuation, the cylinder piston 430 is moved in the direction toward the front part 200. This causes the front part 200 to be separated from the rear part 300.

The cylinder 460 is therefore a double-acting cylinder. The different pressure differences on connection and separation between p1 and p2 are based on the fact that the boundary surface 433 of the chamber 465 is larger than the boundary surface 431 of the chamber 466.

The front part 200 has an encircling stop surface 210. This encircling stop surface extends in this case and by way of example as an encircling partial surface 210 of an encircling groove 212 on the outer surface 220. What is meant by the outer surface 220 is the entire outer surface of the front part 200, it being possible for this entire outer surface to be formed by multiple components and outer surfaces. The stop surface 210 has, radially in relation to the longitudinal axis L, an angle α formed between the longitudinal axis L and the stop surface 210 of by way of example 70°. With preference, the surface 414 in the closed state of the fingers 411 has an angle β formed radially in relation to the longitudinal axis L between the longitudinal axis L and the surface 414 of by way of example 70°. With preference, at least one of the two surfaces, specifically the stop surface 210 or the surface 414, has such an angle α, β between 45° and 85°. In this way, a component of the force acting radially in the direction of the longitudinal axis L on closing of the fingers 411 is directed into the axial direction along the longitudinal axis L and facilitates the movement of the front part 200 along the longitudinal axis L in the direction toward the front part 300. Similarly, the opening of the fingers 411 is also facilitated.

FIG. 1a shows the fingers 211 in what is referred to as the closed state, the tips 412 make contact with the stop surface 210 and retain the front part. The outer sleeve 440, by way of its inner surface 441, keeps the fingers 411 in the described position.

FIG. 1b shows, illustrated in more detail, the region of the gripper 410 with a finger 411 with the tip 412 and the surface 414, and also the stop surface 210. The front and rear part 200 and 300 of the machining head 100 are connected to one another and the fingers 411 are closed, i.e. they make contact with the stop surface 210 by means of the surface 414. The stop surface 210 has, radially in relation to the longitudinal axis L, an angle α formed between the longitudinal axis L and the stop surface 210 of by way of example 70°. The surface 414 in the closed state of the fingers 411 has an angle β formed radially in relation to the longitudinal axis L between the longitudinal axis L and the surface 414 of by way of example 70°. With preference, at least one of the two surfaces, specifically the stop surface 210 or the surface 414, has such an angle α, β between 45° and 85°. In this way, a component of the force acting radially in the direction of the longitudinal axis L on closing of the fingers 411 is directed into the axial direction along the longitudinal axis L and facilitates the movement of the front part 200 along the longitudinal axis L in the direction toward the rear part 300. Similarly, the opening of the fingers 411 is also facilitated.

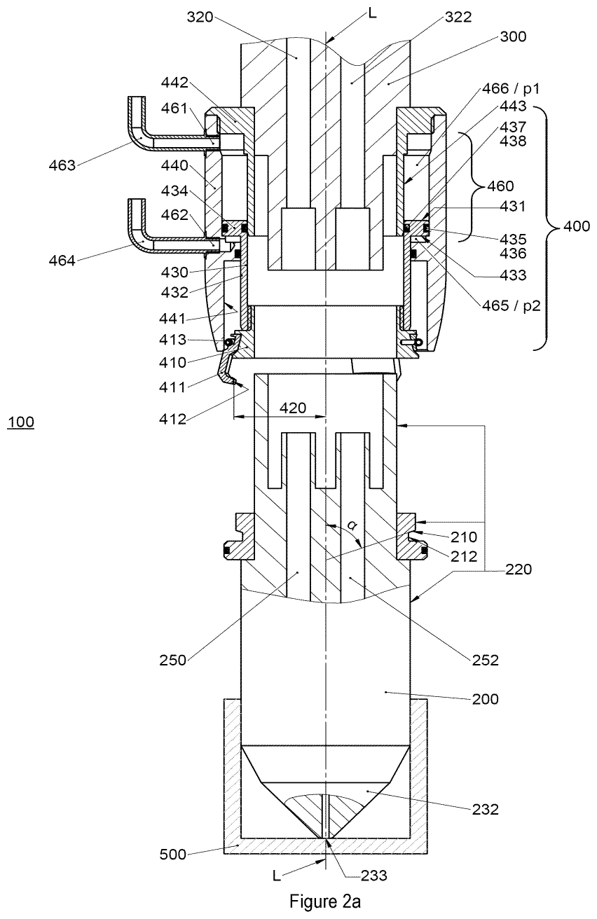

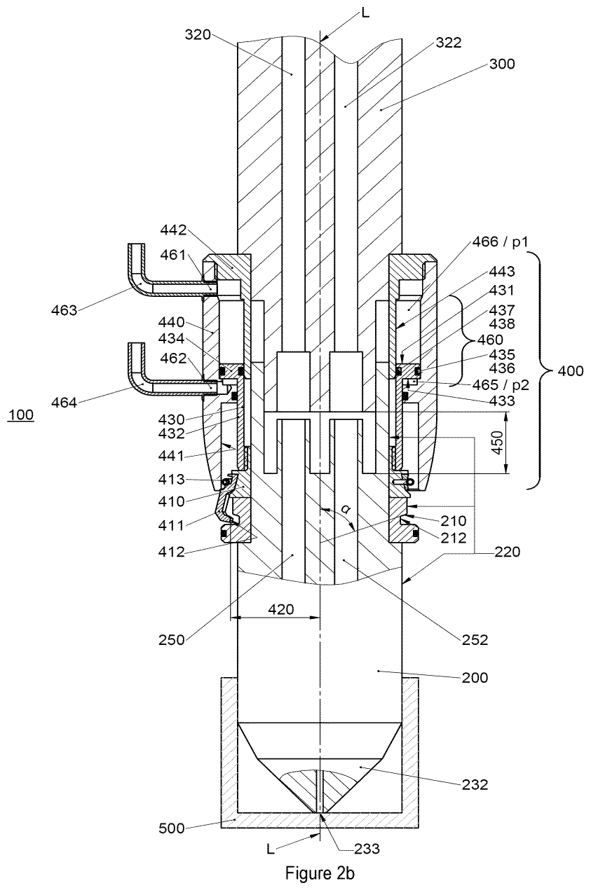

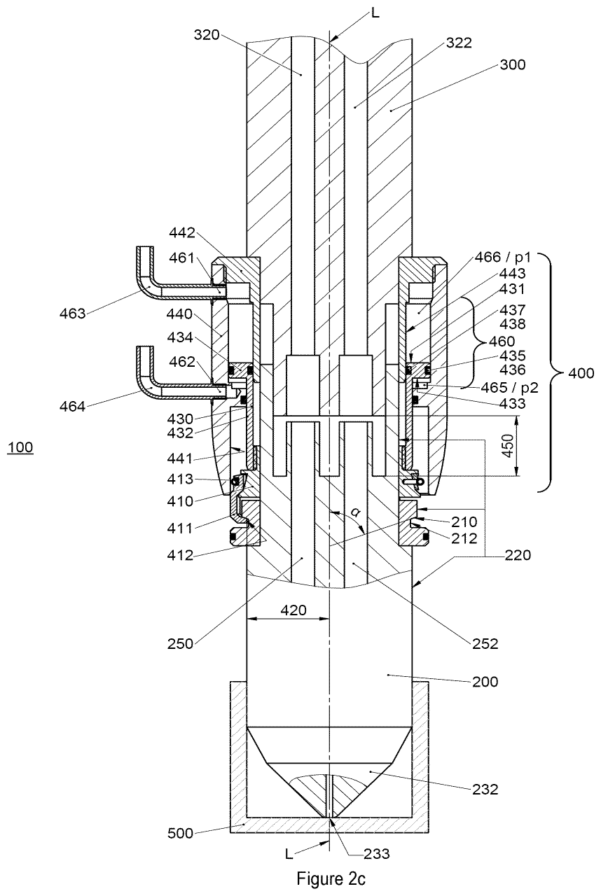

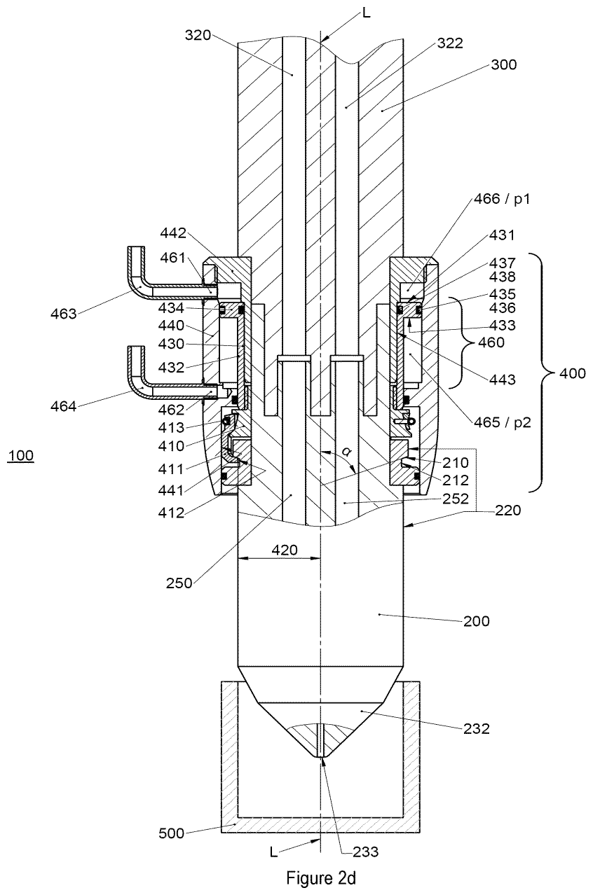

FIGS. 2a to 2d illustrate by way of example the operation of connecting the front part 200 to the rear part 300 of the machining head 100 from FIG. 1.

### Connecting Operation

### FIG. 2a

The rear part 300 of the machining head 100, which is fastened in a mount, not illustrated, of a guide system, is positioned by the guide system above the front part 200 of the machining head 100, the front part being located in a receptacle 500. The longitudinal axes L of the front part 200 and rear part 300 should be in line with one another.

The fingers 411 of the gripper 410 are in the open state. The spacing 420 of the tips 412 of the fingers 411 from the longitudinal axis L is larger here than in the closed state, as shown in FIGS. 2c and 2d. The resilient element 413 acting on the fingers 411 keeps them in the open state. The resilient element can also be a for example magnetically acting element.

### FIG. 2b

The rear part 300 of the machining head is moved by the guide system along the longitudinal axis L in the direction toward the front part 200, until the tips 412 of the fingers 411 of the gripper 410 are axially closely underneath the stop surface 210.

### FIG. 2c

Any existing fluid pressure p1 in the chamber 466 is evacuated through the fluid passage 461. Then, a fluid pressure p2 is guided via the line 464 through the fluid passage 462 into the chamber 465. This causes the component 430, here for example a cylinder piston 430 and thus also the gripper 410, to be moved in the direction toward the rear part 300.

The relative movement of the gripper 410 in relation to the outer sleeve 440 moves the fingers 411, by way of the inner surface 441 of the outer sleeve 440, counter to the spring force exerted by the resilient element 413 in the direction of the longitudinal axis L until the tips 412 make contact with the stop surface 210. The resilient element can also be a magnetically acting element. Then, the front part 200 is moved, by way of the fixing by the fingers, further in the direction toward the rear part 300; the two parts are connected to one another.

### FIG. 2d

Here, the front part 200 and the rear part 300 of the machining head 100 are connected to one another and the movement of the front part 200 in the direction toward the rear part 300 along the longitudinal axis L is completed. The fingers 411 of the gripper 410 are in the closed state. The spacing 420 of the tips 412 of the fingers 411 from the longitudinal axis L is smaller here than in the open state, as shown in FIGS. 2a and 2b. The fluid pressure p1 in the chamber 465 persists. This can be achieved by continuing to provide the pressure through the line 464. This can for example also be achieved by closing the line using a solenoid valve.

Then, the guide system can guide the machining head 100 for further machining of a workpiece.

### Separating Operation

The front part 200 is separated from the rear part 300 in the reverse sequence of FIGS. 2a to 2d:

### FIG. 2d

The front part 200 and rear part 300 of the machining head 100 are connected to one another. The fingers 411 of the gripper 410 are in the closed state. The spacing 420 of the tips 412 of the fingers 411 from the longitudinal axis L is smaller here than in the open state, as shown in FIGS. 2a and 2b.

The machining head 100, which is fastened in a mount, not illustrated, of a guide system, is positioned by the guide system above the receptacle 500. The longitudinal axes L of the machining head 100 and the receptacle 500 should be in line with one another.

### FIG. 2c

Any existing fluid pressure p2 in the chamber 465 is evacuated through the fluid passage 462. Then, a fluid pressure p1 is guided via the line 463 through the fluid passage 461 into the chamber 466. This causes the component 430, here for example a cylinder piston 430 and thus also the gripper 410, to be moved in the direction toward the front part 200.

### FIG. 2b

The component 430, here for example a cylinder piston 430 and thus also the gripper 410, are moved further in the direction toward the front part 200.

Due to the relative movement of the gripper 410 in relation to the outer sleeve 440, the restriction on the fingers 411 by the inner surface 441 of the outer sleeve 440 is ended, and as a result of the spring force of the resilient element 413 is moved and opened in the direction away from the longitudinal axis L. The resilient element can for example also be a magnetically acting element. The tips 412 no longer make contact with the stop surface 210. Then, the front part 200 is separated from the rear part 300. The travel 450 covered by the front part for the purpose of separation from the rear part is in this case and by way of example 18 mm.

### FIG. 2a

The rear part 300 of the machining head is moved by the guide system along the longitudinal axis L in the direction away from the front part 200.

Then, the guide system can move the rear part 300 of the machining head 100 to another front part 200 and connect them to one another.

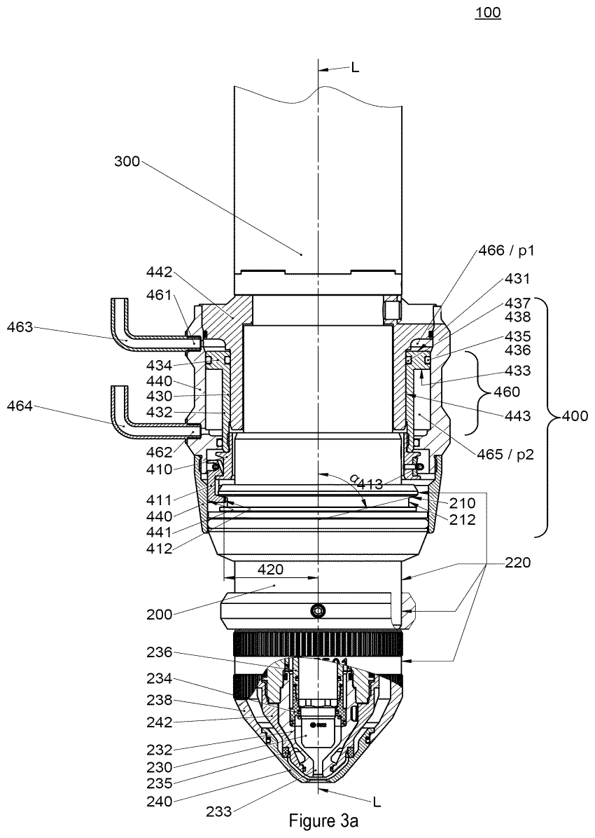

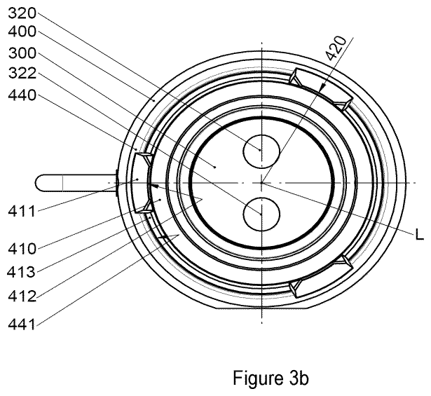

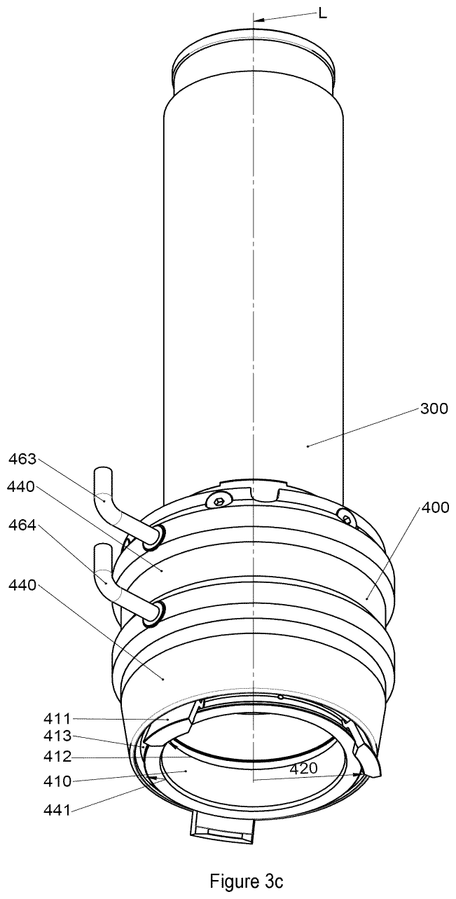

FIG. 3a shows by way of example a side view of a machining head in the form of a plasma torch 100 according to one particular embodiment of the present invention, the front part being a torch head 200 and the rear part being a torch shaft 300. The two parts are illustrated in a state connected detachably to one another.

The plasma torch 100 extends along a longitudinal axis L and comprises a torch head 200 and a torch shaft 300, and also a drive device 400.

The torch head 200 comprises a nozzle 232 with a nozzle opening 233, which during operation has thermal and mechanical energy for workpiece machining leaving it. The torch head 200 also comprises an electrode 230, a gas routing means 234, an insulating part 236, a nozzle cap 242, a secondary gas cap 240, a retaining cap 238.

In the torch head 200, an electrical arc is used to generate a thermal plasma with a very high temperature, for example 30 000 K. The arc (not illustrated) burns between the electrode 230 and the nozzle 232 or between the electrode 230 and the workpiece (not illustrated). The opening, here referred to as nozzle bore 233, constricts the plasma jet and the plasma jet exiting the nozzle bore 233 acts on the workpiece thermally owing to its high temperature and also mechanically owing to its high kinetic energy. The plasma gas flows through a gas routing means 234 into the space between the electrode 230 and the nozzle 232 and is ionized by the arc.

Also illustrated here is a secondary gas cap 240, which is fixed by a retaining cap 238. Between the secondary gas cap 240 and the nozzle cap 242 flows a secondary gas, which is fed to the plasma jet to influence its properties outside of the nozzle 232. The secondary gas is routed by a gas routing means 235 into the space between the nozzle cap 242 and the secondary gas cap 240. The nozzle cap 242 fixes the nozzle 232 and in the space between the nozzle cap 242 and the nozzle 232 flows a cooling liquid, in the simplest case water.

The torch shaft 300 comprises feed lines 320, 322 for gas and electrical current. It may also contain further feed lines for water, for example as cooling medium, for further gases, for example secondary gas or electrical current, and comprise the passages for these media for feeding them to the torch head 200. They are not illustrated in FIG. 3a.

The drive device 400 is situated in this case on the torch shaft 300.

In the drive device 400 there is the gripper 410, which has the fingers 411, here by way of example three of them, with the tips 412 and a resilient element 413. The resilient element can for example also be a magnetically acting element.

Furthermore, the drive device 400 comprises a cylinder 460, which has an outer sleeve 440, which here by way of example is in two parts, an inner sleeve 442 and a cylinder piston 430, comprising a cylindrical sleeve 432 and an encircling flange 434. The inner sleeve 442, the outer sleeve 440 and the cylinder piston 430 form two chambers 465 and 466. The outer sleeve has two fluid passages 461 and 462. The fluid passage 461 connects the chamber 466 to a line 463 and the fluid passage 462 connects the chamber 465 to a line 464, these lines being for the feed of compressed air into and the evacuation of the respective chamber.

The compressed-air feed and the evacuation are controlled in this case and by way of example via solenoid valves and a control device, which are not illustrated here. The two chambers 465 and 466 are separated by the flange 434, which has, encircling its inner surface and its outer surface, a groove 435 and 437, respectively, with an O ring 436 and 438, respectively, for sealing with respect to the inner surface 443 of the outer sleeve 440 and to the outer surface 441 of the inner sleeve 442.

If a pressure is fed to the chamber 465 and the chamber 466 has a pressure considerably lower, preferably a pressure at least 3 bar lower, than the chamber 465 and at best is virtually pressure-free owing to the evacuation, the cylinder piston 430 is moved in the direction toward the torch shaft 300, or kept in this position illustrated here. This makes it possible to connect the torch head 200 to the torch shaft 300.

If a pressure is fed to the chamber 466 and the chamber 465 has a pressure lower, preferably a pressure at least 1 bar lower, than the chamber 466 and at best is virtually pressure-free owing to the evacuation, the cylinder piston 430 is moved in the direction toward the torch head 200. This causes the torch head 200 to be separated from the torch shaft 300.

The cylinder 460 is therefore a double-acting cylinder.

The different pressure differences on connection and separation between p1 and p2 are based on the fact that the boundary surface 433 of the chamber 465 is larger than the boundary surface 431 of the chamber 466.

The torch head 200 has an encircling stop surface 210. This encircling stop surface extends in this case and by way of example as an encircling stop surface 210 of an encircling groove 212 on the outer surface 220. What is meant by the outer surface is the entire outer surface of the front part, it being possible for this entire outer surface to be formed by multiple components and outer surfaces. The stop surface 210 has, radially in relation to the longitudinal axis L, an angle α formed between the longitudinal axis L and the stop surface 210 of by way of example 70°. This has the effect that the tip 412 of the finger 411 together with the stop surface 210 in the connected state of the front part 200 and rear part 300 only establish contact along a line or at certain points and easy opening and closing of the fingers 411 is enabled. The fingers 411 are in the closed state, the tips 412 make contact with the stop surface 210 and retain the torch head 200. The outer sleeve 440, by way of its inner surface 441, keeps the fingers 411 in the described position.

The connection of the torch head to the torch shaft and the separation of the torch head from the torch shaft are effected in the way illustrated in FIGS. 2a to 2d.

FIG. 3b shows by way of example a view of the drive unit 400 of the torch shaft 300 of the plasma cutting torch from FIG. 3a, as seen from the torch head 200. The torch shaft 300 is shown in a state in which it is not connected to the torch head 200. The fingers 411 are open.

The feed lines 320, 322 for gas and current can be seen in the torch shaft 300.

The drive device 400 is shown with the constituent parts of the gripper 410, with the fingers 411 with the tips 412 and with a resilient element 413, in this case an encircling spring. The encircling spring 413 applies load to the fingers 411 such that they are open. The tips of the fingers are at a spacing 420 from the longitudinal axis L which is greater than when the torch shaft 300 and the torch head 200 are connected to one another.

In the separated state, which is not shown here, the inner surface 441 of the outer sleeve 440 makes contact with the fingers 411 and presses them counter to the spring force exerted by the resilient element 413 in the direction toward the longitudinal axis L.

FIG. 3c shows a 3D view of the torch shaft 300 with the drive unit 400. The torch shaft 300 is likewise shown in a state in which it is not connected to the torch head 200. The fingers 411 are open.

The drive device 400 is likewise shown with the constituent parts of the gripper 410, with the fingers 411 with the tips 412 and with a resilient element 413, in this case an encircling spring. The encircling spring 413 applies load to the fingers 411 such that they are open. The tips of the fingers are at a spacing 420 from the longitudinal axis L which is greater than when the torch shaft 300 and the torch head 200 are connected to one another.

In the separated state, which is not shown here, the inner surface 441 of the outer sleeve 440 makes contact with the fingers 411 and presses them counter to the spring force exerted by the resilient element 413 in the direction toward the longitudinal axis L.

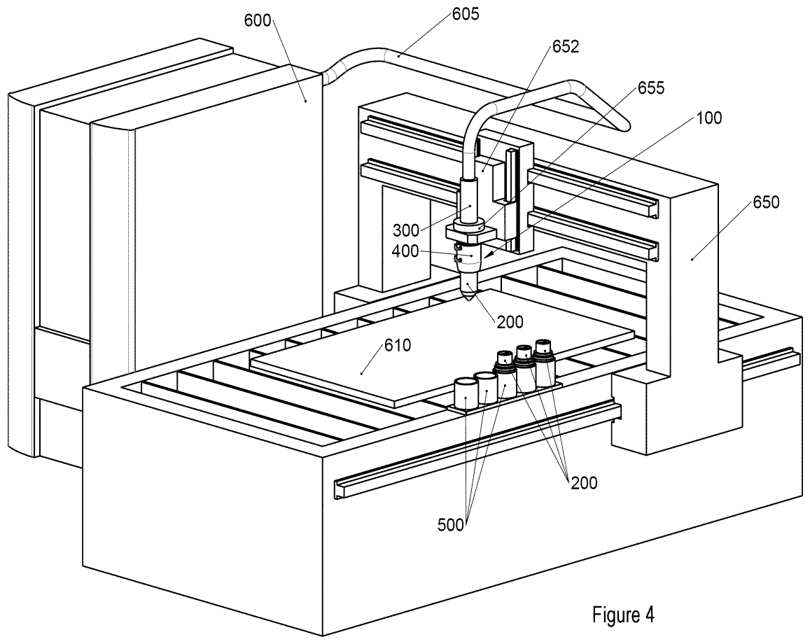

FIG. 4 shows by way of example an arrangement for thermal and/or mechanical machining of workpieces 610, which comprises a machining head 100 according to the invention and an energy supply unit 600 for the machining head 100, the energy supply unit being connected by one or more lines 605 for supplying for example energy, gas and/or cooling water, and a mechanical and/or automatic guide system 650 for guiding the machining head 100. Furthermore, the guide system 650 comprises a spacing adjustment means 652, which adjusts the spacing of the nozzle 232 of the machining head 100 from a workpiece 610 to be machined, and an anticollision means 655, which on an undesired collision of the machining head 100, for example with the workpiece 610, interrupts the movement of the guide system.

The guide system 650 guides the machining head 100 to machine, in this case to cut, the workpiece 610. Furthermore, the guide system 650 also guides the machining head 100 to the receptacles 500, where the exchange of the front parts 200 by separation and connection of the rear part 300 from and to the front part 200 as per the description in FIGS. 2a to 2d is effected. During or after the separating operation, a front part 200 is placed in a deposition location 500 by way of the rear part 300 using the drive device 400, and before or during the receiving operation the front part 200 is removed from the receptacle 500 by way of the rear part 300 using the drive device 400.

When the method for thermal and/or mechanical machining of workpieces 610 is an arc and/or plasma method, the machining head 100 is an arc torch, a plasma torch, a plasma arc torch, a plasma welding torch, a TIG torch or a plasma cutting torch. The rear part 300 is in that case a torch shaft and the front part 200 a torch head. The torch head comprises at least one nozzle 232 with an opening 233 and an electrode 230. It may also comprise for example an electrically insulating part 236 and/or a gas routing means 234 and/or a further cap 238, 240. The torch shaft 300 comprises in this example at least one feed line 250, 252 for a fluid and/or for an electrical current. The energy supply unit 600 is a current source, which is connected via at least one or more lines 605 to the torch shaft 300 for transmission of energy, gas or cooling water.

When the method for thermal and/or mechanical machining of workpieces 610 is a combustion process by a combustible gas, the machining head 100 is a gas torch. The rear part 300 is a torch shaft and the front part 200 a torch head. The torch head 200 comprises at least one nozzle 232. The torch shaft 300 comprises at least one feed line 250, 252 for a fluid. The energy supply unit is for example a gas supply unit for combustible gas, for example propane, hydrogen, acetylene.

When the method for thermal and/or mechanical machining of workpieces 610 is a laser method, the machining head 100 is a laser machining head. The rear part 300 is a laser shaft and the front part 200 a laser head. The laser head comprises at least one nozzle 232. The laser shaft comprises at least the feed line for a gas and for the laser radiation. The energy supply unit is a laser beam generator, for example a fiber laser, a diode laser or a gas laser.

When the mechanical machining method is a waterjet blasting method, the machining head 100 is a waterjet-blasting machining head. The rear part 300 is a waterjet-blasting shaft and the front part 200 a waterjet-blasting head. The waterjet-blasting head comprises at least one nozzle 232. The waterjet-blasting shaft comprises at least one feed line 250, 252 for a fluid. The energy supply unit 600 is a pressure generator, for example a pump.

The features of the invention that are disclosed in the above description, in the drawings and in the claims may be essential for the implementation of the invention in its various embodiments both individually and in any desired combinations.

### List of Reference Signs

100 Machining head
200 Front part, torch head
210 Stop surface
212 Groove
220 Outer surface
230 Electrode
232 Nozzle
233 Opening
234 Gas routing means
235 Gas routing means
236 Insulating part
238 Cap (retaining cap)
240 Cap (secondary gas cap)
242 Cap (nozzle cap)
250 Feed line
252 Feed line, existing
300 Rear part, torch shaft
310 Stop surface
320 Feed line
322 Feed line
400 Drive device
410 Gripper
411 Finger
412 Tip
413 Resilient or magnetic element
414 Surface
420 Tip-longitudinal axis spacing
430 Component, cylinder piston
431 Surface
432 Sleeve
433 Surface
434 Flange
435 Groove
436 O ring
437 Groove
438 O ring
440 Outer sleeve
441 Inner surface of the outer sleeve
442 Inner sleeve
443 Outer surface of the inner sleeve
444 Sleeve
450 Travel
460 Cylinder
461 Fluid passage
462 Fluid passage
463 Line
464 Line
465 Chamber
466 Chamber
500 Receptacle
600 Energy supply unit
610 Workpiece
650 Guide system
652 Spacing adjustment means
655 Anticollision means
L Longitudinal axis
p1 Fluid pressure
p2 Fluid pressure
α Angle
β Angle

1. A machining head for thermal and/or mechanical machining of workpieces, which extends along a longitudinal axis L, comprising:
a front part and a rear part;
said front part comprising at least one nozzle with an opening, which during operation has thermal and/or mechanical energy for workpiece machining leaving it;
said rear part connected or connectable to operating-media supply devices; and
said rear part and said front part connectable detachably to and separable from one another;
wherein said rear part and/or said front part have/has a drive device, which are/is configured to move said front part at least partially along the longitudinal axis L relative to said rear part for connection purposes and in the opposite direction relative to said rear part for separation purposes.

2. The machining head of claim 1, wherein said drive device is operable one of pneumatically, hydraulically, mechanically, electromechanically, magnetically and electromagnetically.

3. The machining head of claim 2, further comprising said drive device having at least one cylinder that is operable one of pneumatically, hydraulically, electromechanically, magnetically and electromagnetically.

4. The machining head of claim 3, further comprising said cylinder is a double-acting cylinder.

5. The machining head of claim 4, wherein said double-acting cylinder configured to provide a connecting force which is smaller than the separating force that it provides.

6. The machining head of claim 1, wherein a travel along the longitudinal axis L for connecting and/or separating is at least 2 mm.

7. The machining head of claim 1, further comprising said drive device has at least one gripper.

8. The machining head of claim 7, further comprising said at least one gripper has at least one movable finger and one tip.

9. The machining head of claim 8, further comprising said at least one gripper has one, two, three, or four movable fingers.

10. The machining head of claim 8, wherein a spacing between the longitudinal axis L of the machining head and said tips of said fingers of said gripper is smaller or larger in the connected state than in the separated state.

11. The machining head of claim 10, further comprising said machine head is configured such that a change in said spacing is triggered by a movement of a component and/or of a sleeve and/or of the gripper of said drive device along the longitudinal axis L.

12. The machining head of claim 11, further comprising said at least one finger is at least partially movable by at least one resilient and/or magnetic element.

13. The machining head of claim 8, further comprising said rear part comprising said drive device and said front part comprising at least one stop surface for said tips of said at least one finger is of said gripper or said front part comprising said drive device and said rear part comprising at least one stop surface for said tips of said at least one finger is of said gripper.

14. The machining head of claim 13, further comprising a nozzle and/or a cap and said at least one stop surface extending at least partially around a circumference of an outer surface of said front part and/or of an outer surface of said nozzle and/or of said cap and/or of an outer surface of said rear part of the machining head.

15. The machining head of claim 14, further comprising said stop surface having, radially in relation to the longitudinal axis L, at least one portion of which an angle α formed between the longitudinal axis L and said stop surface is smaller than 85° and greater than 45° and/or a surface of said fingers of said gripper in a closed state of said fingers having, radially in relation to the longitudinal axis L, at least one portion of which an angle β formed between the longitudinal axis L and said surface is smaller than 85° and greater than 45°.

16. The machining head of claim 1, wherein a travel for separating or connecting said front part and said rear part being at least 10 mm.

17. The machining head of claim 1, wherein the machining head is used for one of cutting, welding, coating, and heating.

18. The machining head of claim 17, wherein the machining head is used for machining of electrically conductive or electrically non-conductive materials.

19. The machining head of claim 17, further comprising the machining head is one of an arc torch, a plasma torch, a plasma arc torch, a plasma welding torch, a TIG torch, and a plasma cutting torch.

20. The machining head of claim 19, further comprising the machine head having a torch head, which comprises at least one electrode and one nozzle with an opening, and a torch shaft, which comprises at least one feed line for a fluid or for an electrical current.

21. The machining head of claim 20, wherein said torch head also comprises at least one electrically insulating part, at least one gas routing part, or at least one further cap.

22. The machining head of claim 17, wherein the machining head is a torch for machining with combustible gas and configured to generate thermal energy by the combustion of said combustible gas.

23. The machining head of claim 22, wherein the machining head has a torch head, which has at least one nozzle, and a torch shaft, which comprises at least one feed line for a fluid.

24. The machining head of claim 17, wherein the machining head has a head and a shaft for laser machining.

25. The machining head of claim 24, wherein the machining head has a laser head, which comprises at least one nozzle, and a laser shaft, which comprises at least one feed line for a gas or for laser radiation.

26. The machining head of claim 17, wherein the machining head has a head and a shaft for waterjet machining.

27. The machining head of claim 26, wherein the machining head has a waterjet-blasting head, which comprises at least one nozzle, and a waterjet-blasting shaft, which comprises at least one feed line for a fluid.

28. An arrangement for mechanical and/or thermal machining of workpieces comprising:
at least one machining head for thermal and/or mechanical machining of workpieces, which extends along a longitudinal axis L, comprising:
a front part and a rear part;
said front part comprising at least one nozzle with an opening, which during operation has thermal and/or mechanical energy for workpiece machining leaving it;
said rear part connected or connectable to operating-media supply devices; and
said rear part and said front part connectable detachably to and separable from one another;
wherein said rear part and/or said front part have/has a drive device, which are/is configured to move said front part at least partially along the longitudinal axis L relative to said rear part for connection purposes and in the opposite direction relative to said rear part for separation purposes;
at least one receptacle for each said machining head;
an energy supply unit; and
a mechanical and/or automatic guide system for guiding each said machining head.

29. The arrangement of claim 28, wherein said guide system comprises an apparatus for open-loop or closed-loop control or adjustment of a spacing between said nozzle of said machining head and a workpiece or an anticollision device for said machining head.

30. The arrangement of claim 28, further comprising:
said at least one machining head:
for one of cutting, welding, coating, and heating;
for machining of electrically conductive or electrically non-conductive materials; and
is one of an arc torch, a plasma torch, a plasma arc torch, a plasma welding torch, a TIG torch, and a plasma cutting torch;
wherein said at least one machine head having a torch head, which comprises at least one electrode and one nozzle with an opening, and a torch shaft which comprises at least one feed line for a fluid or for an electrical current or wherein said torch head also comprises at least one electrically insulating part, at least one gas routing part, or at least one further cap;
a current source for providing electrical energy for said at least one machining head; and
a gas supply for providing gases for said machining head.

31. The arrangement of claim 30, further comprising a coolant unit for supplying a coolant to said at least one machining head.

32. The arrangement of claim 28, further comprising:
said at least one machining head is used for one of cutting, welding, coating, and heating, said machining head is a torch for machining with combustible gas and configured to generate thermal energy by the combustion of said combustible gas; and
a gas supply for provisioning said machining head.

33. The arrangement of claim 28, further comprising:
said at least one machining head is used for one of cutting, welding, coating, and heating, said machining head has a head and a shaft for laser machining;
a laser beam source for providing laser radiation; and
a gas supply for providing gases for said machining head.

34. The arrangement of claim 28, further comprising:
said at least one machining head is used for one of cutting, welding, coating, and heating, and said machining head has a head and a shaft for waterjet machining; and
a high-pressure pump for providing water pressure for said machining head.

35. A method for connecting and separating a front part and a rear part of a machining head for thermal and/or mechanical machining of workpieces, the machining head extending along a longitudinal axis L the front part comprising at least one nozzle with an opening, which during operation has thermal and/or mechanical energy for workpiece machining leaving it, the rear part connected or connectable to operating-media supply devices the front and/or the rear part comprising a drive device and the front part being moved relative to the rear part toward one another for connecting purposes and being moved relative to the rear part away from one another for separating purposes.

36. The method of claim 35, further comprising the drive device has at least one gripper that has at least one movable finger and one tip, and the connecting operation comprises the following steps:
a. positioning the rear part and the front part of the machining head in axial alignment;
b. applying a fluid pressure to a fluid passage;
c. moving a component in the direction toward the rear part along the longitudinal axis L by means of the drive device;
d. closing the fingers of the gripper; and
e. moving the component further along the longitudinal axis L and connecting the front part to the rear part of the machining head.

37. The method of claim 35, further comprising the drive device has at least one gripper that has at least one movable finger and one tip, and the separating operation comprises the following steps:
a. applying a fluid pressure a fluid passage;
b. moving a component in the direction toward the front part along the longitudinal axis L by means of the drive device;
c. opening the fingers of the gripper; and
d. releasing the front part.

38. The method of claim 36, wherein the front part prior to the connecting operation is in a receptacle.

39. The method of claim 36, further comprising evacuating a chamber by way of said fluid passage prior to step a, b, or c.

40. The method of claim 37, further comprising evacuating a chamber by way of said fluid passage prior to step a. or b.

41. The method of claim 35, wherein positioning of the machining head is effected by a guide system or manually.

42. The method of claim 35, further comprising the drive device has at least one gripper that has at least one movable finger and one tip, and the opening and/or closing of the fingers of the gripper is effected by a spring force and/or by a mechanical delimitation and/or magnetically.

43. The method of claim 37, wherein the front part after the separating operation is placed in a receptacle.
